(19) United States
(12) Patent Application Publication
(10) Pub. No.: US 2003/0187675 A1
(43) Pub. Date: Oct. 2, 2003

(54) Business process valuation tool

(76) Inventors: Stefan Hack, Wiesloch (DE); Shaun Elliott, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/161,474

(22) Filed: May 31, 2002

Related U.S. Application Data
(60) Provisional application No. 60/369,020, filed on Mar. 29, 2002.

(51) Int. Cl. G06F 17/60

(52) U.S. Cl. 705/1

(57) ABSTRACT

A strategic management tool that calculates a business value. The tool selects at least one relevant business process, presents key performance indicators associated with the relevant business process, and derives a value equation based on a subset of key performance indicators.

### REFERENCE TO RELATED APPLICATION

This application claims priority from U.S. provisional patent application No. 60/369,020, filed on Mar. 29, 2002, entitled “Strategic Opportunity Management Tools and Electronic Business Casebuilder,” which is incorporated herein by reference in its entirety.

### TECHNICAL FIELD

This invention relates to a strategic opportunity management tool, and in particular, to a business process valuation tool.

### BACKGROUND

An industry is typically comprised of business entities that interact with other business entities. The business entities may include market participants who may use software tools to make decisions regarding how best to interact with other business entities.

The market participants in an industry may have many business processes that are used to interact with other market participants in the industry or participants from other industries. Business processes may be defined as one or more activities that a business implements in order to achieve a specific business result. For example, a manufacturer may have an objective to meet a production schedule. In order to achieve that objective, the manufacturer may implement an inventory management system to assure adequate components for manufacturing. The participant may be able to select from the processes a subset that is most relevant and value-adding to the participant's role. For example, retailer in a consumer products industry may determine that a process for enhancing end consumer goodwill is more relevant than a process for managing inventory. In contrast, a wholesale distributor in a oil and gas industry may decide that a process for managing inventory is more relevant than a process for enhancing end consumer goodwill. The retailer in the consumer products example above may choose to implement a business process such as customer relations management (CRM) to enhance customer goodwill, whereas the distributor in the oil and gas industry may decide to implement a business process such as supply chain management (SCM) or materials resource planning (MRP) to enhance inventory control.

The market participant may find it necessary to assess qualitative and/or qualitative information to determine the impact of implementing each of the business processes in the relevant and value-adding processes subset. With this information, the market participant may choose between implementing the various processes. For example, while SCM and MRP are both valuable in controlling inventory, the participant may need a metric to decide which process or combination to implement. Such qualitative and quantitative information may include return on investment (ROI), net present value (NPV), payback period, customer goodwill or other intangible benefits, or other information relating the impact of the business process to the market participant's company.

### SUMMARY OF THE DISCLOSURE

In one aspect, a method is disclosed for calculating a business value that may include selecting at least one relevant business process, identifying a subset of key performance indicators associated with the relevant business process, and deriving a value equation based on a subset of key performance indicators. The aforesaid method may include associating key performance indicators (KPIs) with each of the business processes. The method may include calculating a metric based on the value equation.

A second aspect is an article comprising a computer-readable medium storing computer-executable instructions that when applied to one or more computers causes the computers to perform the method disclosed above.

In a third aspect, a system is provided that includes one or more computers configured to perform the method disclosed above.

In various implementations, the above techniques may provide one or more of the following advantages. A value calculation may be based on a subset of business processes that the participant has determined to be relevant and value-adding. The calculated value may be based on business factors such as cost advantages, revenue growth opportunities and intangible benefits. A market participant may be provided with a quantitative value that includes metrics, such as net present value, which may improve the decision making process of the market participant. For example, a manufacturer in the consumer products industry may have to make a decision whether to implement a business process such as supply chain management (SCM) program because of a business need such as processing orders. The market participant may be able to make a more informed decision if he/she is provided with a value associated with the use of the SCM program.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is block diagram of a strategic opportunity management system according to one implementation.

FIG. 1B is process diagram of a strategic opportunity management system according to one implementation.

FIG. 2 is a flowchart showing the operation of various aspects of the strategic opportunity management system according to one implementation.

FIGS. 3A-3B depict output from a strategic opportunity management system according to one implementation.

Like reference symbols in the various drawings indicate like elements.

### DETAILED DESCRIPTION OF ILLUSTRATIVE EMBODIMENTS

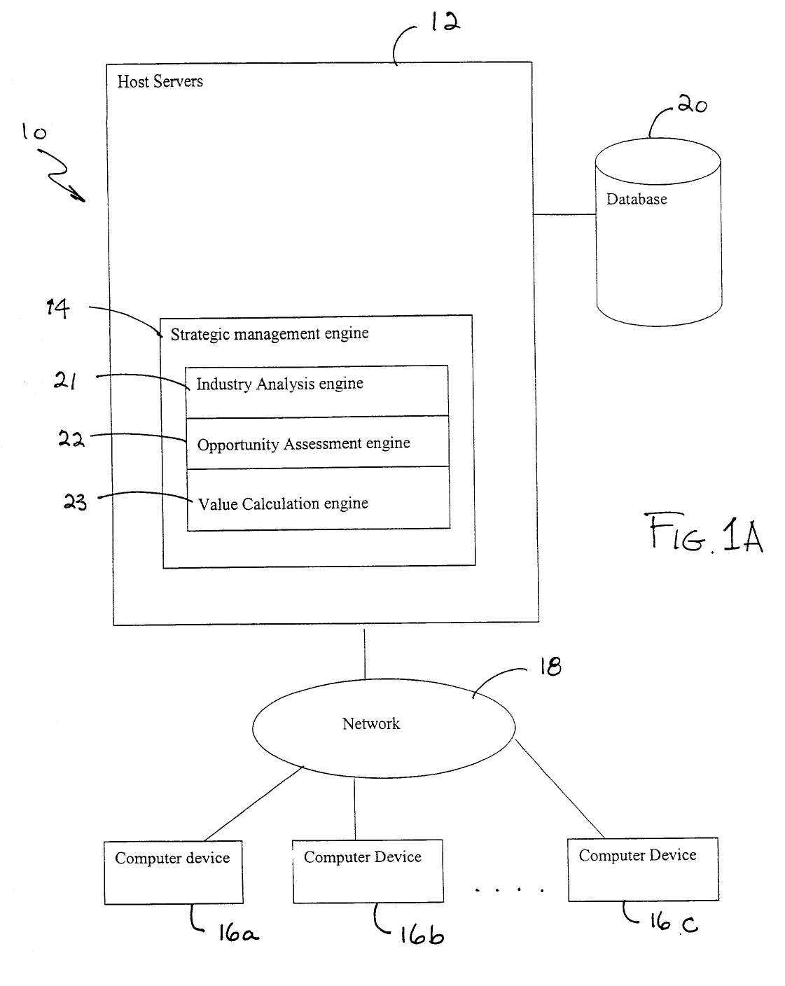

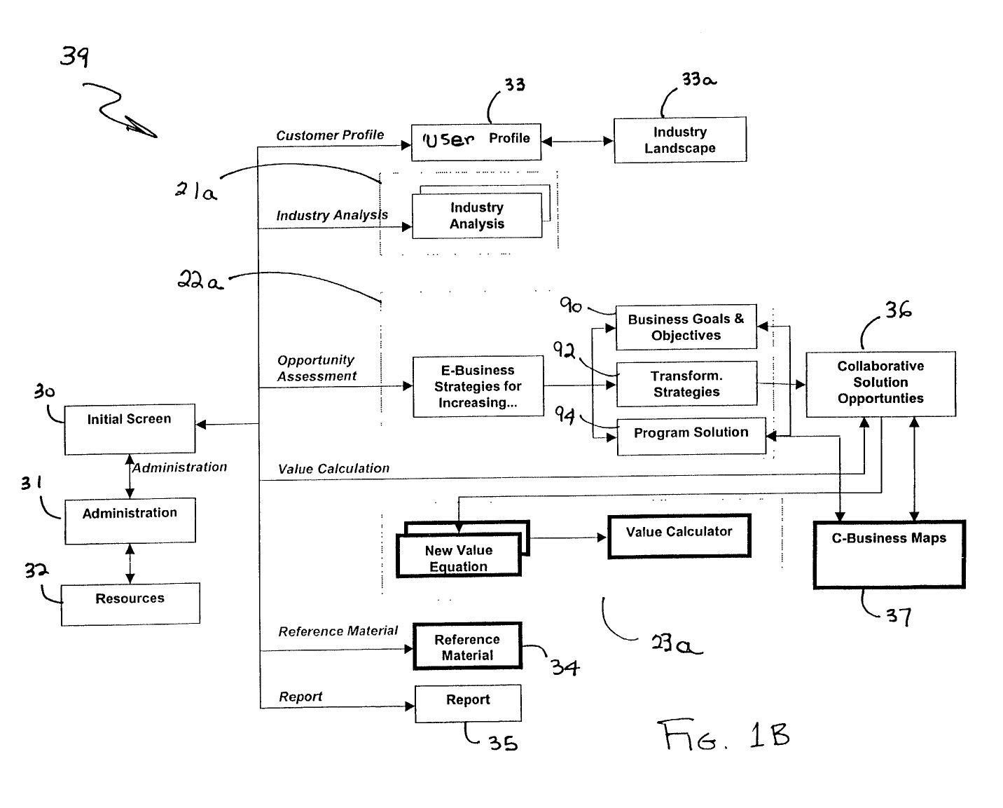

FIG. 1A is a block diagram of a strategic opportunity management system 10. The system 10 includes one or more host servers 12 that includes a strategic management engine 14 that may be accessed by user using computer devices 16a, 16b, . . . 16n over a network 18. The strategic management engine 14 includes an industry analysis engine 21, an opportunity assessment engine 22, and a value calculation engine 23. In certain embodiments, the system 10 provides information to assist a user in analyzing a strategic opportunity. Such information may include, for example, industry data relevant to a customer, a list of business scenarios relevant to the user, proposed business strategies and objectives, proposed products and services that meet the business strategies and objectives, and a high level calculation of the value (e.g., return on investment) that may be provided by implementation of the products and services that meet the identified business strategies and objectives.

The host servers 12 of FIG. 1A may include, for example, an Internet-accessible server. The strategic management engine 14 may be distributed and executed on one or more host servers 12. A database 20 may be used by the host servers 12 to store and retrieve information related to the operation of the host servers 12 including the execution of the strategic management engine 14. The network 18 may include a plurality of devices such as servers, routers and switching circuits connected in an intranet, extranet or Internet configuration.

A user may use a computer device, such as computer device 16a, to access the host servers 12 over a network 18. The computer device 16a may include a personal computer (PC), personal digital assistant (PDA) or other device using wireless or wired communication protocols to access the host servers 12. The computer device 16a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices.

FIG. 1B is a process diagram of an implementation of a strategic opportunity management system 10. Processes 39 may be implemented using a graphical user interface. The processes 39 may include an “initial” display 30 of information related to the system 10 such as a description of the purpose and the output of the system. A “user profile” 33 may allow the user to enter information related to the industry that is of interest to the user. This information may be used to identify an industry from an industry landscape that may include a plurality of industries. For example, a user in the consumer products industry may desire to select information related to that industry from among a plurality of industries. “Administration” 31 may be provided to manage a user's profile including providing a “create” area that allows the user to create a new user profile and a “view/edit” area that allows the user to view or edit a previously created user profile. User profile information includes information provided by the user which may be used during the operation of the strategic management engine 14. However, to gain access to the system 10, the “administration” 31 may require the user to provide uniquely identifiable information such as a company name and/or a profile identifier. The identifiable information provided by the user may be compared with user information previously stored in the host servers 12 to determine whether the user currently attempting to access the system 10 is authorized to access the system. “Resources” 32 may provide links and Email addresses for business case resources such as business case systems, competitive information, business case development and consulting, sales support, evaluation and design tools, public information, or other resources.

If the user is authorized to access the system 10, the user may select the “industry analysis” 21a function from the processes 39. This engine, in certain embodiments, may help the user identify an industry sector from a predetermined industry landscape that includes a plurality of industry sectors. Examples of industry sectors include consumer products, utilities, chemicals, oil and gas, and the like. The “industry analysis” 21a also may provide or conduct, in selected implementations, an industry analysis. The industry analysis may include defining participants in terms of their function or role. For example, in the consumer products sector, the participants may include a manufacturer, supplier, retailer, intermediate manufacturer, distributor, and the like. The industry analysis may also identify market forces associated with the selected industry sector for each role. In an illustrative embodiment, trends related to a manufacturer may include tight labor markets, shift toward a retail demand focus, and rapidly shifting consumer preferences. Details concerning certain of the identified market factors may also be displayed. The system may optionally also display solutions/responses to certain of the identified market factors (e.g., one-to-one customer interaction in response to tight labor market). The system may also identify industry trends being pursued by other firms in the selected industry sector(s). The industry analysis may also provide case examples. The information and/or analysis may be derived from databases and other such sources.

An “opportunity assessment” 22a function, in certain embodiments, may assess and generate data concerning one or more opportunities, or may provide proposed business strategies suitable for the selected industry sector. For example, a manufacturer in an consumer products industry may be able to analyze data related to changes in consumer demand. Opportunities may A user may select role or participant functionality. For instance, in the consumer products industry sector, the participants may include a manufacturer, distributor, retailer, and the like. The system may also be configured to permit the user to select a business maturity for various facets of the participant entity, such as strategy, infrastructure, technology, and business culture. “Business maturity” is that period during which an enterprise seeks to secure market position, optimize investment opportunities, and explore product and market diversification. The “opportunity assessment” 22a section may allow identification of value-added business processes and/or strategies. For example, some versions may feature three ways to identify business strategies. The first presents transformation strategies 92. The second identifies proposed business goals and strategies 90. The third presents various solution areas that logically group various strategies 94.

In the first method 92 of identifying value-added strategies, transformation strategies are defined and presented along with proposed complementary strategies that will produce a shortlist of relevant and value-adding business strategies for the user. The user may select for further analysis one or more strategies from a list of strategies recommended by the system. For example, a user, such as a manufacturer in a consumer products industry, may select for further analysis the transformational strategy “customer self-service.” In response, the system may provide and/or describe “complementary business strategies” such as “one-to-one customer interaction” or customer life-cycle management. By reviewing the transformational strategies, the customer may identify which method or methods are most appropriate for their business.

In the second method 90, business objectives are presented with a list of possible specific plans to accomplish those objectives A user may select one or more of the plans for further analysis. For example, a user, such as a manufacturer in a consumer products industry, may select a Business Goal such as “reducing operating costs” or “lowering working capital.” For each goal, the system may provide one or more business objectives such as “reduce inventory levels” or “improve procurement processes” to achieve the selected goal. This method of producing a shortlist of relevant and value-adding business processes may require more detailed user input that the transformational strategies method, and may be more suitable for a business unit operational head.

The third method 94 of identifying value-added business strategies presents various solution areas that logically group various strategies. A user may select a group of strategies based on problem statements or questions associated with a strategy group. For example, a “customer relationship management” group of strategies may offer the problem statement “Are your high-value customers getting the service they deserve?” The system may display a list of business scenarios (e.g., collaborative sales processes, key account management). After reviewing the aforementioned information, the user may rank the relative importance of each business scenario. The rankings of the importance of the business scenarios may help to define a set of strategies. This method may be more targeted than the other two methods, and may be more suitable for the tactical business processes appropriate for functional managers.

The results of “opportunity assessment” 22a may be provided to “collaborative solution opportunities” 36 function and “C-business maps” (Collaborative Business Maps) 37 function. The “C-business maps” 37 function refers to a method of viewing and modeling business scenarios using program solutions. It provides a visual representation of business processes and typical employee roles and presents the benefits and potential value that may be achieved by using these solutions. The “collaborative solution opportunities” 36 function may identify information technology (IT) tasks required to implement the solutions and determine an array of potential implementations to facilitate those tasks. See, for example, U.S. provisional patent application No. 60/369,020, filed on Mar. 29, 2002, entitled “Strategic Opportunity Management Tools and Electronic Business Casebuilder.”

A “value calculation” 23 a function may calculate the value of the strategies selected by the user (such selection may occur in the foregoing steps in certain embodiments). The system may identify software products and related services that may be used to implement or facilitate the strategies identified in the previous steps. The value calculation may be based on customer-provided input regarding potential value or savings. For instance, the user may input cost advantages (e.g., potential procurement cost reduction), revenue growth opportunities (e.g., improved order fill rate), and intangible benefits (e.g., goodwill). The system then generates a report that may identify business concerns such as return on investment, payback period, and/or net present value associated with the proposed solution(s).

“Reference material” 34 may be used to maintain links to reference material that might be of interest to a particular user. For example, the material may include presentations, spreadsheets, information regarding Websites, or other material. An output report for the user that may include information from the above functions or screens may be generated at “report” 35. The format of the report may be a soft copy, such as a printed version, a hard copy such as an electronic file in the host server 12, or other format that may be in machine or human readable format.

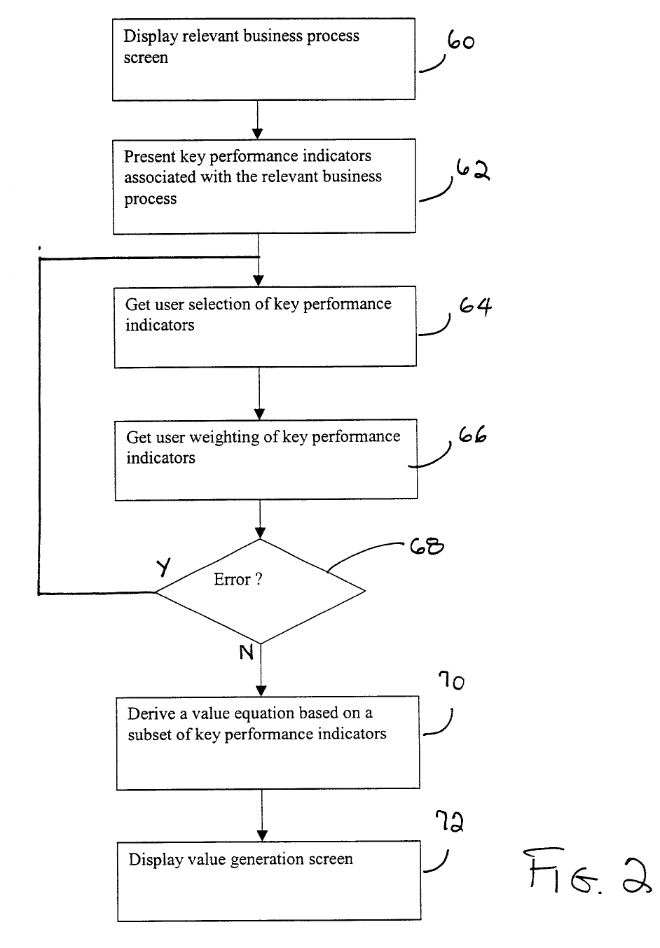

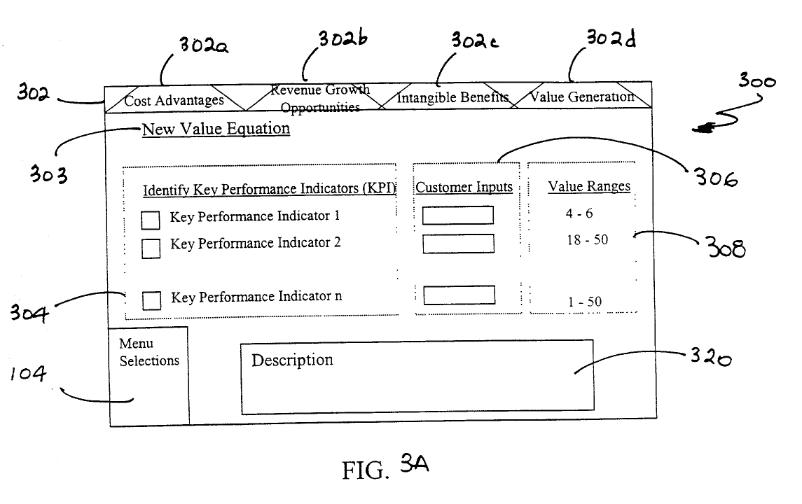

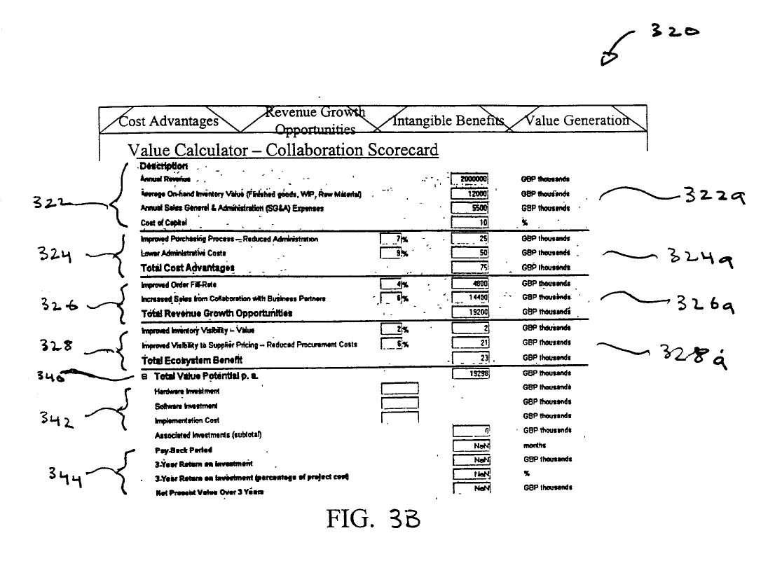

FIG. 2 is a flowchart showing the operation of the value calculation engine 14c portion of the strategic opportunity management system 10. The system 10 displays 60 a relevant business screen which may be based on a relevant business process or scenario selected by the user. For example, referring to FIG. 3A, the system 10 displays a “value calculation” screen 300. A business process may be defined as a set of processes used to address a business need in a business. For example, a manufacturer in a consumer products industry may have a business need to process orders from a customer. A business process, such as a supply chain management program, may provide a solution to the business need to process orders from the customer. The value calculation engine 14c may perform a value calculation based on the strategies selected by the user (such selection occurs in the foregoing steps in certain embodiments).

The “value calculation” screen 300 includes “business factor” tabs 302. A business factor may be defined as an aspect of a business that that may be included in the value calculation. A header 303 may show an example of a value calculation based on business factors such as “cost advantages”, “revenue growth opportunities”, and “intangible benefits.” The “business factor” tab 302 includes tab 302a representing a “cost advantage” screen, tab 302b representing a “revenue growth opportunities” screen, and tab 302c representing an “intangible benefits” screen. Each of the business factor screens may display a value calculation area 303 that shows how the different business factors are used in the value calculation. Each of the business factor screens may provide a key performance indicator (KPI) area 304. For example, the business process of vendor managed inventory (VMI) may be affected by KPIs including lower administrative costs, improved purchasing process, and so on. A KPI may represent a factor that affects the business process. The user may select a KPI from the KPI area 304 and enter data in a corresponding KPI area 306. In addition, the KPI areas 304 and 306 may be associated with a value range 308 which may be used to provide guidance to the user when entering data into the KPI areas. A description 310 for each highlighted KPI area 304 may also be provided.

Referring to FIG. 2, the system 10 then presents 62 key performance indicators (KPI) associated with the relevant business process. The user may then select at least one business factor associated with the business process. For example, referring to FIG. 3A, the user may select a business factor such as “cost advantage” which is highlighted as shown at 302. The system displays KPIs that are brought to bear on the business factor. The user selects which KPIs are of most interest to the user. In this manner, the total KPIs listed 304 is filtered to reflect the KPIs of interest to the user. In another implementation, the system 10 may select the relevant KPIs based on the business process selected.

Referring back to FIG. 2, the user may then select 64 a subset of KPIs 304. The user inputs 66 data 306 for the KPIs that are of interest to the user. The system may check 68 that the user entries are within the acceptable value ranges (See, for example, 308 in FIG. 3A). If an error is detected, the system returns to block 64 and may prompt the user to enter an acceptable value. The user also may select other business factors and follow the same procedure as described above for the other business factors.

If no error is found at 68, the system 10 derives 70 a value equation based on the subset of key performance indicators. The system then displays 72 a value generations screen. For example, after the user has completed entering information into the business factor screens described above, the user selects the “value generation” tab 302d as shown in FIG. 3A. As a result, the “value generation screen” 320 is displayed as shown in FIG. 3B. The “value generation” displays a value that is based on a market participant in an industry who has selected a business process. The value provides an indication of the financial impact of selecting the business process based on the user's business needs. For example, a manufacturer in the consumer products industry may evaluate the impact that a decision may have on the business to use a “vendor management inventory” business process for a business need associated with receiving orders for a product produced by the manufacturer.

The system produces the “value generation” screen 320 which may include a financial figures area 322 requiring the user to enter financial information such as annual revenue, on-hand inventory, sales general and administration expenses. A calculation field 322a may display the result of performing a calculation on the data from the corresponding data from the financial figures area 322. The value generation screen 320 may also display a “total cost advantages” area 324 which includes data from the KPIs 324a and KPI ranges 324b from screen 310 in FIG. 3A. A calculation field 324a may display the result of performing a calculation on the data from the corresponding data from the total cost advantages area 324. Likewise, a “total revenue growth opportunities” area 326 and a “total intangible” area 328 may also be provided with similar functionality to the area 324. Calculation fields 326a and 328b may display the result of performing a calculation on the data from the corresponding data from the areas 326 and 328, respectively. A “pop up” display 330 may be used to show mathematical formulae used to calculate the values in the calculation fields 322a, 324a, 326a and 328a. The “pop-up” display may be produced when a pointing device, such as a mouse computer device, is moved over the calculated field.

Referring again to FIG. 2, once the value generation has been determined, a metric may be calculated 66 which may be based on the value generations described above. The metric may include, for example, net present value, payback period, return on investment, or other financial metric. It also may take into consideration other investment information such as the amount of hardware and software investment and the corresponding implementation cost. Referring to FIG. 3A, the “value generation” screen 320 may include a total potential value area 340 which may be further divided into an “investment” area 342 and a “metric” area 344. The “investment” area 342 may allow the user to enter information regarding investments which may be used in the metric calculation. The “metric” area 344 may provide the user with one or more calculated metric values such as those mentioned above, including a net present value, payback period, and return on investment. The user may review the values of the metrics 344, which may be either negative or positive, to determine whether to select a particular business process, such as vendor management inventory, to solve the business need.

Once the value calculation is complete, the system 10 may provide the user with a report that may include information used during the operation of the strategic opportunity management engine 14. The report may be produced in a format such as, for example, a “hard copy” version such as a printout, a “soft copy” version such as a computer file, or other format. This may be accomplished by having the user select a “report” function from the “option” menu 104 of any of the screens of the system 10.

Those skilled in the art will appreciate from the foregoing description that the methods and apparatus identified herein may be advantageously modified in an almost limitless number of ways. For instance, one or more of the foregoing techniques may be advantageously performed in isolation or in any desired combination or order. The software may be configured to be executed on any variety of platforms, such as intranets, wireless networks, and local hard disks by way of non-limiting example. The software may be executed on one or more computers, host servers or distributed host servers. The systems and techniques described herein may be implemented in environments without software, including as “paper and pencil” versions. Any amount of proprietary content may be incorporated into this system, such as propriety business models, industry trends, and market forces. Any aspect of the business strategy evaluation, value calculations, etc. may be implemented at a finer granularity by use of more detailed information, models, inputs and/or algorithms, for example. None of the particular techniques need be performed in the order indicated unless specifically stated. To the contrary, the techniques may be freely modified by substituting and/or reordering steps as suitable for particular implementations. Any output from the system described herein may be presented in any manner suitable for a particular user, and may include any aspect of the business strategies, industry trends, and market forces described herein.

Various features of the system may be implemented in hardware, software, or a combination of hardware and software. For example, some aspects of the system may be implemented in computer programs executing on programmable computers. Each program may be implemented in a high level procedural or object-oriented programming language to communicate with a host servers.

Furthermore, each such computer program may be stored on a storage medium, such as read-only-memory (ROM), readable by a general or special purpose programmable computer, for configuring and operating the computer when the storage medium is read by the computer to perform the functions described above.

Other implementations are within the scope of the following claims.

What is claimed is:

1. A method for calculating a business value comprising:
identifying a subset of relevant business processes based on a selection of at least one of an industry and market participant;
identifying key performance indicators associated with the subset of relevant business processes; and
deriving a value equation based on the subset of key performance indicators.

2. The method of claim 1 wherein the key performance indicators are selected from at least one of automated replenishment, improved purchasing process, lower administrative costs, reduced inventory levels, reduced procurement costs and improved visibility into supplier pricing.

3. The method of claim 1 wherein the value equation includes addends calculated from the key performance indicators.

4. The method of claim 1 further comprising prompting a user to select at least one key performance indicator.

5. The method of claim 1 further comprising identifying a narrower subset of key performance indicators based on a user's selection.

6. The method of claim 1 wherein the value equation is derived automatically from the subset of relevant business processes.

7. The method of claim 1 wherein the value equation is specific to the selected industry and market participant.

8. An article comprising a computer-readable medium storing computer-executable instructions that when applied to one or more computers cause the computers to:
identify a subset of relevant business processes based on a selection of at least one of an industry and market participant;
identify key performance indicators associated with the subset of relevant business processes; and
derive a value equation based on the subset of key performance indicators.

9. The article of claim 8 further comprising instructions that when executed by the computers prompt a user to select at least one key performance indicator.

10. The article of claim 8 comprising instructions that when executed by the computers identify a narrower subset of key performance indicators based on a user's selection.

11. A system for calculating a value, the system comprising one or more computers configured to:
identify a subset of relevant business processes based on a selection of at least one of an industry and market participant;
identify key performance indicators associated with the subset of relevant business processes; and
derive a value equation based on the subset of key performance indicators.

12. The system of claim 11 further comprising one or more computers configured to prompt a user to select at least one key performance indicator.

10. The system of claim 11 further comprising one or more computers configured to identify a narrower subset of key performance indicators based on a user's selection.

11. The system of claim 11 wherein the value equation includes addends calculated from the key performance indicators.

12. The system of claim 11 wherein the value equation is derived automatically from the subset of relevant business processes.

13. The system of claim 11 wherein the value equation is specific to the selected industry and market participant.
